(19) United States
(12) Patent Application Publication
(10) Pub. No.: US 2025/0181888 A1
(43) Pub. Date: Jun. 5, 2025

(54) SHARD STORAGE METHOD AND APPARATUS FOR GRAPH AND SUBGRAPH SAMPLING METHOD AND APPARATUS FOR GRAPH

(71) Applicant: Alipay (Hangzhou) Information Technology Co., Ltd., Hangzhou (CN)

(72) Inventor: Zhongshu ZHU, Hangzhou (CN)

(21) Appl. No.: 18/966,490

(22) Filed: Dec. 3, 2024

(30) Foreign Application Priority Data
Dec. 4, 2023 (CN) 202311670679.0

(51) Int. Cl. G06N 3/04

(52) U.S. Cl. CPC G06N 3/04

(57) ABSTRACT

Embodiments of this specification provide a shard storage method and apparatus for a graph and a subgraph sampling method and apparatus for a graph. In a distributed storage process of a graph, local identifiers of a vertex and an edge are implicitly stored, and data is stored in an ordered manner, so that the local identifiers of the vertex and the edge can be implicitly calculated. A connecting edge is stored in a CSR format, to ensure that a first-order neighbor of a node is contiguously stored in a memory. In this way, there can be a higher data loading speed and lower memory occupation.

### TECHNICAL FIELD

One or more embodiments of this specification relate to the field of graph data application technologies, and in particular, to a shard storage method and apparatus for a graph and a subgraph sampling method and apparatus for a graph.

### BACKGROUND

A graph can describe various entities or concepts in the real world and their relationships, and can include a large semantic network graph in which a node represents an entity or a concept (or can be represented as an entity corresponding to a concept or an instance), and an edge corresponds to a property of an entity or a relationship between entities. The graph can include, for example, a knowledge graph, a bipartite graph, or an isomorphic and homogeneous graph (including one type of node and one type of edge, for example, a social graph or a transaction graph).

In actual applications of the graph, an amount of data in the graph may be large, for example, at a level of tens of billions or hundreds of billions. An important application of graph data is to model a node in the graph by using a graph neural network (GNN), and then predict, by using a trained model, whether there is a specific edge between nodes. As the scale of graph data continues to expand and a graph structure becomes increasingly complex (for example, a heterogeneous graph and a multigraph), it is difficult for a single machine to support graph data at a level of billions or even hundreds of billions. A conventional solution can be implemented based on a distributed graph sampling system, and small-scale subgraphs are obtained as inputs to a GNN model by using various sampling policies. Specifically, a graph cutting task is first executed on full graph data, and the graph data is cut into a plurality of shards, to ensure that a scale of each shard can be loaded into a memory of a single device. Then, the distributed subgraph sampling system is started to load graph data obtained through cutting and provide sampling services to the outside. In a downstream GNN model training/inference task, the subgraph sampling system is accessed to obtain, in real time, a sampled small-size subgraph, and the small-size subgraph is input to the model. As a key component of the entire procedure, the distributed subgraph sampling system needs to support data loading and query operations with high performance and low memory overheads, and further needs to support multi-dimensional data retrieval, to meet sampling condition requirements of various GNN model algorithms. Therefore, the distributed subgraph sampling system may become a bottleneck of the entire procedure.

### SUMMARY

One or more embodiments of this specification describe a shard storage method and apparatus for a graph and a subgraph sampling method and apparatus for a graph, to resolve one or more problems mentioned in the background.

According to a first aspect, a shard storage method for a graph is provided, performed by a single distributed device, and used to store a current shard of the graph in a distributed system. The method includes: storing, in a form of a first vector, node identifiers corresponding to all nodes in the current shard in the graph; and storing connecting edges of all the nodes in a compressed sparse row format based on a node sequence in the first vector, where the compressed sparse row format of the connecting edges corresponds to a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes.

In an embodiment, when the graph is a directed graph, the connecting edges include an outgoing edge and an incoming edge, and storing the connecting edges of all the nodes in the compressed sparse row format based on the node sequence in the first vector includes: storing each of the outgoing edge and the incoming edge in a compressed sparse row format based on the node sequence in the first vector.

In an embodiment, for all the nodes, single nodes are sorted based on connecting edge types in the compressed sparse row format of the connecting edges.

In an embodiment, the method further includes: storing connecting edge types of all the nodes in a compressed sparse row format based on the node sequence in the first vector, where the compressed sparse row format of the connecting edge types corresponds to a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes.

According to a second aspect, a subgraph sampling method for a graph is provided, performed by a single distributed device in a distributed system that stores the graph, and used to sample a first subgraph related to a current node in a locally stored graph shard. The method includes: querying a first vector including node identifiers corresponding to all nodes in a current shard in the graph, to determine a first location of the current node in the first vector; determining a first-order neighbor node of the current node from a compressed sparse row format vector of connecting edges based on the first location, where the compressed sparse row format of the connecting edges corresponds to at least a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes; and a node identifier of each first-order neighbor node is determined in the following manner: determining, by using the first row statistics vector, a first quantity of connecting edges corresponding to the current node; and obtaining, based on a node location indicated by the first column index vector, an identifier of a node connected to the first quantity of connecting edges; and completing a sampling operation of the first subgraph in the current device based on the current node and each first-order neighbor node.

In an embodiment, the first quantity is a data difference between a first location and a previous location in the first row statistics vector.

In an embodiment, the first location is determined by searching the first vector for a node identifier of the current node by using a dichotomy.

In an embodiment, obtaining, based on the node location indicated by the first column index vector, the identifier of the node connected to the first quantity of connecting edges includes: determining the node location indicated by the first column index vector as a local identifier of a node connected to each connecting edge; and querying a corresponding node identifier in the first vector based on the local identifier.

In an embodiment, single nodes are sorted based on connecting edge types in the compressed sparse row format of the connecting edges, the connecting edge types are stored in a compressed sparse row format of a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes; and determining the first-order neighbor node of the current node from a compressed sparse row format vector of connecting edges based on the first location includes: searching the second column index vector for quantities of connecting edges respectively corresponding to all edge types corresponding to the current node; determining, based on the quantities of connecting edges and a storage location of the current node in the second data vector, a location range corresponding to an identifier of an edge type that needs to be sampled; and obtaining, from the first vector based on the location range, a node identifier of each node connected to the edge type that needs to be sampled.

In an embodiment, completing the sampling operation of the first subgraph in the current device based on the current node and each first-order neighbor node includes: performing neighbor node sampling on each first-order neighbor node until a predetermined condition is met to complete the sampling operation of the first subgraph in the current device, where the predetermined condition is, for example, that a neighbor node of a predetermined order of the current node is sampled, or a quantity of nodes sampled for the first subgraph reaches a predetermined quantity threshold.

According to a third aspect, a shard storage apparatus for a graph is provided, disposed in a single distributed device, and configured to store a current shard of the graph in a distributed system. The apparatus includes:
a first storage unit, configured to store, in a form of a first vector, node identifiers corresponding to all nodes in the current shard in the graph; and
a second storage unit, configured to store connecting edges of all the nodes in a compressed sparse row format based on a node sequence in the first vector, where the compressed sparse row format of the connecting edges corresponds to a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes.

According to a fourth aspect, a subgraph sampling apparatus for a graph is provided, disposed in a single distributed device in a distributed system that stores the graph, and configured to sample a first subgraph related to a current node in a locally stored graph shard. The apparatus includes:
a first query unit, configured to query a first vector including node identifiers corresponding to all nodes in a current shard in the graph, to determine a first location of the current node in the first vector;
a second query unit, configured to determine a first-order neighbor node of the current node from a compressed sparse row format vector of connecting edges based on the first location, where the compressed sparse row format of the connecting edges corresponds to at least a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes; and a node identifier of each first-order neighbor node is determined in the following manner: determining, by using the first row statistics vector, a first quantity of connecting edges corresponding to the current node; and obtaining, based on a node location indicated by the first column index vector, an identifier of a node connected to the first quantity in of connecting edges; and
a sampling unit, configured to complete a sampling operation of the first subgraph in the current device based on the current node and each first-order neighbor node.

According to a fifth aspect, a computer-readable storage medium is provided. The computer-readable storage medium stores a computer program, and when the computer program is executed in a computer, the computer is enabled to perform the method according to the first aspect or the second aspect.

According to a sixth aspect, a computing device is provided, including a storage and a processor. The storage stores executable code, and when the processor executes the executable code, the method according to the first aspect or the second aspect is implemented.

According to the method and apparatus provided in the embodiments of this specification, in a distributed storage process of a graph, local identifiers of a vertex and an edge are implicitly stored, and data is stored in an ordered manner, so that the local identifiers of the vertex and the edge can be implicitly calculated, to save storage space of the local identifier and a mapping relationship between a local identifier and a global identifier. A connecting edge is stored in a CSR format, to ensure that a first-order neighbor of a node is contiguously stored in a memory. For a heterogeneous graph, a connecting edge type is also stored in a CSR format, there is no need to split all edges into a plurality of sparse matrices based on types, and query does not need to be performed across a plurality of sparse matrices in a sampling process. Therefore, better sampling performance can be achieved. In addition, because no complex container structure such as a map or a vector is introduced, there can be a higher data loading speed and lower memory occupation.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram of a specific applicable architecture of this specification;

FIG. 2 is a schematic diagram of two cases of vertex cutting and edge cutting in graph cutting;

FIG. 3 is a schematic diagram of a specific subgraph storage format of a technical concept in this specification;

FIG. 4 is a schematic diagram of a shard storage procedure for a graph performed by a single distributed device according to an embodiment;

FIG. 5 is a schematic diagram of a subgraph sampling procedure for a graph performed by a single distributed device according to an embodiment;

FIG. 6 is a schematic block diagram of a shard storage apparatus for a graph disposed in a single distributed device according to an embodiment; and

FIG. 7 is a schematic block diagram of a subgraph sampling apparatus for a graph disposed in a single distributed device according to an embodiment.

### DESCRIPTION OF EMBODIMENTS

The technical solutions provided in this specification are described below with reference to the accompanying drawings.

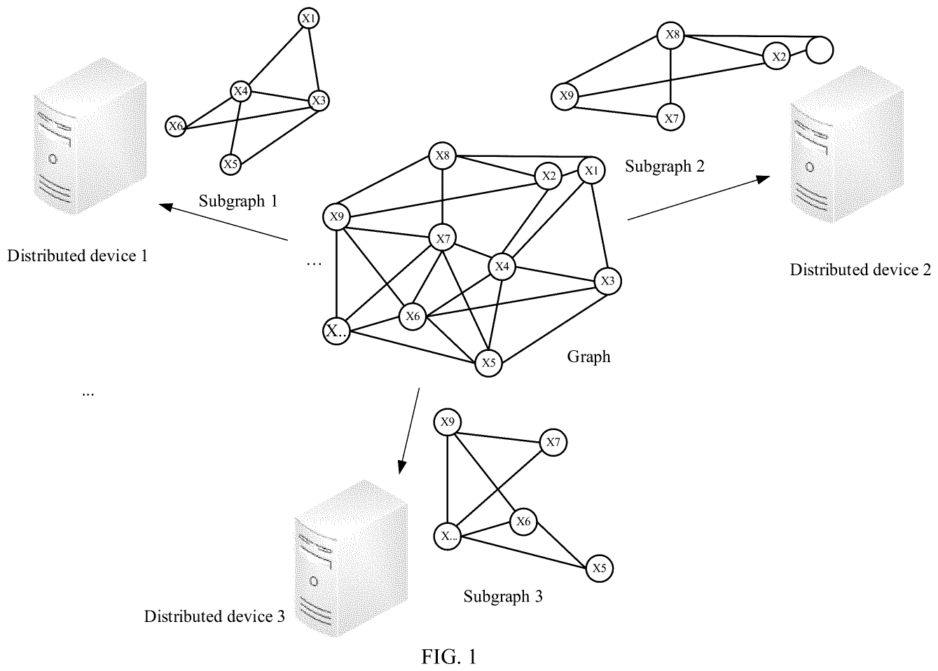

FIG. 1 is a schematic diagram of a specific applicable architecture of this specification. As shown in FIG. 1, the applicable architecture of this specification is a distributed architecture. The distributed system can include a plurality of devices, for example, a distributed device 1, a distributed device 2, and a distributed device 3 in FIG. 1 (in practice, there can be more distributed devices in the distributed system). In graph applications, a graph usually needs to be split into a plurality of subgraphs for storage in the distributed system. As shown in FIG. 1, the graph is split into a subgraph 1, a subgraph 2, a subgraph 3, etc. (in practice, more subgraphs can be obtained through splitting), which are respectively stored in the distributed devices.

A person skilled in the art can understand that a graph is a structure including a group of nodes and a group of edges used to connect two nodes. The graph can have a relatively complex graph structure, for example, a heterogeneous graph or a multigraph. In the field of graph applications, a homogeneous graph is used to describe a graph structure in which there is only one type of node and one type of edge in a graph (the graph in this specification can be various relational networks, and can include a graph), while nodes and edges in a heterogeneous graph can have a plurality of types of complex structures. For example, in the graph, a node type can be a user, a commodity, a store, etc., and an edge type can be purchase, access, etc. In addition, a multigraph can be a graph structure in which there are a plurality of edges between two nodes. For example, when a node type includes a user and a commodity and an edge type includes purchase, a plurality of times of purchase of a same commodity by a single user at different times can correspond to a plurality of edges between the single user and the commodity. Usually, a new graph including some nodes and edges selected from an original graph is referred to as a subgraph of the original graph.

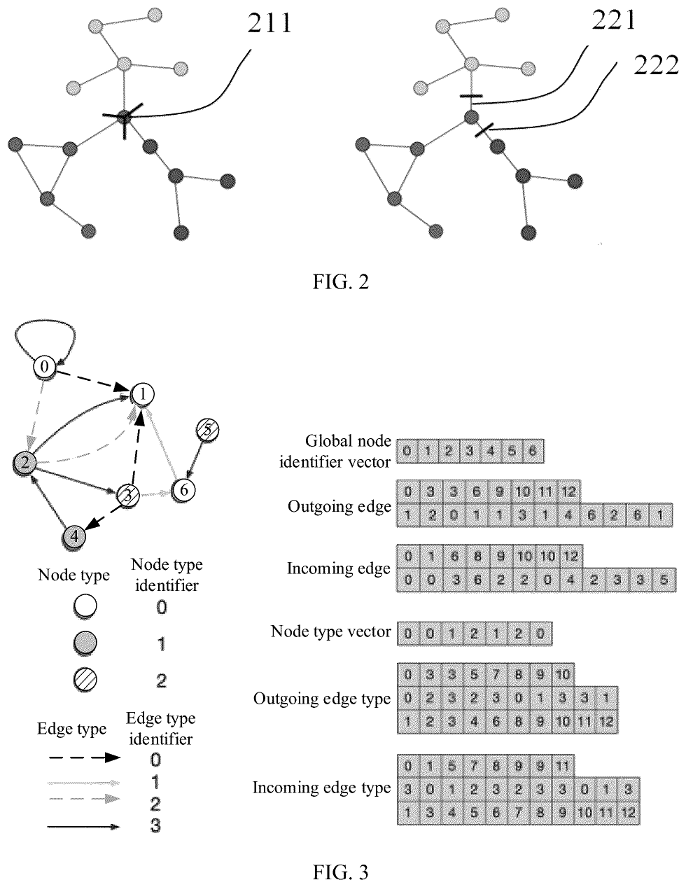

Graph cutting is a process of splitting vertices and edges in the original graph into a plurality of shards (a type of subgraph) based on a specific rule, to facilitate distributed processing on ultra-large-scale graph data. Graph cutting can be classified into vertex cutting and edge cutting. As shown in FIG. 2, vertex cutting is shown on the left side, and edge cutting is shown on the right side. In a vertex cutting process, a single vertex (for example, a vertex 211 in FIG. 2) in a graph may be simultaneously distributed to a plurality of shards, resulting in vertex redundancy. When information about vertices included in a plurality of shards is obtained, cross-shard data query needs to be performed. In an edge cutting process, edges (for example, edges 221 and 222 in FIG. 2) in the graph may be simultaneously distributed to a plurality of shards, resulting in edge redundancy. When information about edges included in a plurality of shards is obtained, cross-shard data query also needs to be performed. A corresponding relational network can be sampled from a subgraph through graph sampling.

In a conventional storage solution, mapping of a global node identifier (global ID) to a local node identifier (local ID) in a shard is usually explicitly stored, and type information of a node is obtained by using the local node ID. In addition, additional storage space, for example, a hash map, is usually required to store the local node ID. In a conventional implementation, a heterogeneous graph is split into a plurality of homogeneous graphs for storage, and each homogeneous graph stores one edge type. In this way, only one vertex/edge type ID needs to be stored for nodes and edges in each homogeneous graph. For a shard including N nodes, each homogeneous graph needs to be represented by an N×N sparse matrix, that is, more space is required to store a graph structure. In addition, because a first-order neighbor edge of each node is distributed in a plurality of sparse matrices, and cannot be stored in contiguous memory space, data query performance may be degraded. In a conventional implementation, an edge type ID is stored for each edge, an edge type index is separately established for a first-order neighbor of each node, and data is stored in a map format, to increase a query speed. In this solution, a large amount of additional space is also occupied, and in most cases, a quantity of edges in a graph is many times or even hundreds of times a quantity of vertices, which may cause severe space waste.

In view of this, this specification provides a technical solution for storing an edge and an edge type in a compressed sparse row (CSR) storage manner of a sparse matrix. Each field is represented in a simple contiguous array form, and there is a relatively high loading speed and relatively low memory occupation. In addition, local IDs of a node and an edge can be implicitly defined by using a location of a global node ID and an edge type. Optionally, data can be further stored in an ordered manner based on a connecting edge type. In this storage manner, data search can be performed with reference to a dichotomy, a mapping relationship between a local ID and a global ID does not need to be additionally stored, and there is lower memory occupation. In conclusion, a subgraph storage process and a subgraph query and sampling process in a service processing process in a distributed system provided in this specification can effectively reduce memory occupation and improve sampling efficiency.

With reference to FIG. 3, a subgraph storage process in the technical concept of this specification is first described below.

Subgraph storage can be performed by a single distributed device in a distributed system that stores a graph. In a storage process of a subgraph (a shard of a graph), at least the following fields can be recorded: a global ID (for example, global id) of a node and a connecting edge (for example, denoted as edge), and a node type (for example, denoted as vertex_type) field and an edge type (for example, denoted as edge_type) field can be further recorded in a heterogeneous graph. In a directed graph, the connecting edge can include an outgoing edge (an edge pointing to another node from a single node, for example, denoted as out_edge) and an incoming edge (an edge pointing to a single node, for example, denoted as in_edge). In this case, the “connecting edge” field in the above-mentioned fields can be replaced with two fields: “outgoing edge” and “incoming edge”.

In the technical concept of this specification, the global node identifier and the node type can be recorded in a vector form, and the connecting edge and the connecting edge type can be recorded in a compressed sparse row CSR form. The CSR form is one of recording manners of a sparse matrix, and usually includes three vectors: a row statistics vector indptr, a column index vector indices, and a data vector data. In a conventional sparse matrix, indptr can record a column index offset of each row, that is, a vector including a cumulative result of a quantity of non-zero values corresponding to each row; indices can store a column index, that is, a column in which the non-zero value is located; and data is used to store the non-zero value. Usually, when all of non-zero values in an adjacency matrix are a predetermined value, the data term can be omitted. It can be understood that the connecting edge can be recorded in a form of an adjacency matrix. A form of the adjacency matrix is, for example, as follows: Rows and columns correspond to nodes, an element of two nodes with a connection relationship at the intersection of a row and a column is a predetermined value (is usually 1), and other elements are 0. Therefore, the adjacency matrix can be considered as a sparse matrix, so that the connecting edge can be recorded in the CSR form.

FIG. 3 shows a specific example of subgraph storage. A connecting edge in a subgraph in this example is a directed edge. As shown in FIG. 3, if global node identifiers of 7 nodes in the subgraph are 0, 1, 2, 3, 4, 5, and 6 (or can be other values), a global node identifier vector (global ids) can be recorded as [0, 1, 2, 3, 4, 5, 6], where locations 0, 1, 2, 3, 4, 5, and 6 corresponding to the global node identifiers can implicitly describe local identifiers of the nodes. A node type vector is used to record an entity type corresponding to each node, for example, a user, a commodity, or a merchant. When a node type is represented by 0, 1, or 2, if types of the nodes 0, 1, 2, 3, 4, 5, and 6 are 0, 0, 1, 2, 1, 2, and 0, the node type vector (vertex types) can be recorded as [0, 0, 1, 2, 1, 2, 0].

Further, an outgoing edge (out_edges) field theoretically corresponds to three vectors indptr, indices, and data. Because the data vector is a predetermined value, descriptions are omitted in the example in FIG. 3. The indptr vector is [0, 3, 3, 6, 9, 10, 11, 12], where the first element 0 is an initial filler value, the second element 3 represents a quantity of outgoing edges of the first node 0, the third element 3 represents a quantity value obtained after a quantity of outgoing edges of the second node 1 and the quantity of outgoing edges of the first node 0 are added, and so on. The indices vector is [1, 2, 0, 1, 1, 3, 1, 4, 6, 2, 6, 1], and includes a total of 12 elements, corresponding to a final cumulative value 12 (the last element) in the indptr vector. Specifically, the quantity of outgoing edges of the first node 0 is 3, and the edges respectively point to three nodes whose location identifiers are 1, 2, and 0; the second node 1 has no outgoing edges; a quantity of outgoing edges of the third node 2 is 3, and the edges respectively point to node locations 1, 1, and 3; and so on. A vector corresponding to an incoming edge (in_edges) field is similar to that corresponding to the outgoing edge. Details are not described herein.

In addition, in the example shown in FIG. 3, it is assumed that there are a total of four type identifiers of connecting edge types: 0, 1, 2, and 3, and an outgoing edge type (out edge types) field theoretically corresponds to three vectors indptr, indices, and data, where indptr collects statistics on a quantity of outgoing edges types corresponding to each node. For example, as described in a vector [0, 3, 3, 5, 7, 8, 9, 10], a quantity of outgoing edge types of the first node 0 is a difference 3−0=3 between the second element and the first element, a quantity of outgoing edge types of the second node 1 is a difference 3−3=0 between the third element and the second element, and so on. Further, the indices vector is [0, 2, 3, 2, 3, 0, 1, 3, 3, 1], and describes an edge type identifier corresponding to the outgoing edge type of each node. For example, the three outgoing edge type identifiers of the first node 0 are 0, 2, and 3, two outgoing edge types of the third node 2 are 2 and 3, and so on. The data vector is [1, 2, 3, 4, 6, 8, 9, 10, 11, 12], and describes a quantity of edges of each type in the indices vector. The corresponding quantity of edges is a difference between a current value and a previous value. For example, for the three types of outgoing edges of the first node 0, there is one edge of the edge type 0, there is 2−1=1 edge of the edge type 2, and there is 3−2=1 edge of the edge type 3; for the two types of outgoing edges of the third node 2, there is 4−3=1 edge of the edge type 2, and there are 6−4=2 edges of the edge type 3; and so on. A recording manner of an incoming edge type is similar to that of the outgoing edge type. Details are not described herein. In a sampling example, when a subgraph corresponding to the service node 4 needs to be sampled, a related connecting edge and node can be queried by using a dichotomy, to form a sampled subgraph. With reference to FIG. 3, if a node at a middle location is first found, and a node identifier is 3, which is less than 4, search is performed on a right side until a node identifier 4 is found, and a corresponding location is a fifth location (describing a local ID). A CSR vector of a corresponding outgoing edge is queried to obtain a quantity 1 of connecting edges indicated by the fifth element in indptr, and the node 2 indicated by the corresponding tenth element in indices is a first-order neighbor of the node 4. In addition, a CSR vector of an incoming edge is queried to obtain a quantity 1 of connecting edges indicated by the fifth element in indptr, and the node 3 indicated by the corresponding tenth element in indices is a first-order neighbor of the node 4. Based on a subgraph sampling requirement, only a first-order neighbor node of a service node can be sampled, or a multi-order neighbor node of a service node can be sampled. When the multi-order neighbor node of the service node needs to be sampled, neighbor node sampling can continue to be performed on the first-order neighbor node. A sampling process is similar to the above-mentioned sampling process of the service node. Details are not described herein.

In some service processing processes, the connecting edge type further needs to be queried. For example, a fusion weight of a node feature is determined based on the connecting edge type. In this case, query can continue to be performed based on a CSR vector of the connecting edge type. For example, for the node 4, if a connecting edge type indicated by the fifth element in indptr of the outgoing edge type is the eighth location, and it is obtained, from the eighth element in indices, that the connecting edge type is 3, it can be determined that a connecting edge type between the node 4 and the node 2 is 3. In addition, if a connecting edge type indicated by the fifth element in indptr of the incoming edge type is the ninth location, and it is obtained, from the ninth element in indices, that the connecting edge type is 0, it can be determined that a connecting edge type between the node 4 and the node 3 is 0.

In a possible design, a connection relationship between nodes is described by using a triplet (head node, connecting edge type, tail node). When a connecting edge is stored in a compressed sparse row format, triplets corresponding to single nodes can be sorted based on connecting edge types. In this way, first-order neighbors of all nodes are sorted based on the connecting edge types, and connecting edge data stored in the compressed sparse row format can be used as a type index of a heterogeneous graph. Specifically, based on sorted connecting edges (for example, an outgoing edge and an incoming edge), quantities of edges corresponding to all edge types (for example, an outgoing edge type and an incoming edge type) of a single node can be calculated, and stored in corresponding edge type fields (for example, an out_edge_types field and an in_edge_types field). In a CSR format of the edge type, an indices vector sequentially stores edge type IDs of all the nodes, and a data vector stores a quantity of edges corresponding to each edge type. When a cumulative operation is performed on data in stored connecting edge data, a local location identifier range corresponding to each edge type can be obtained from a data vector in a CSR format of the connecting edge, to facilitate retrieval in the heterogeneous graph based on the edge type.

With reference to FIG. 3, for example, to obtain a subgraph of a node whose global identifier is 2 in a connection relationship in the edge type 3, the global identifier vector global ids can be first queried to obtain location information of the third location, and the location information can be used as a local identifier of the node 2. By querying the CSR format of the outgoing edge type out edge types, there are (5−3)=2 connecting edge types, namely, the type 2 and the type 3, at the third location, and quantities of edges corresponding to the edge types are (4−3)=1 and (6−4)=2. It can be learned, by querying the data vector, that two pieces of data corresponding to the edge type 3 are the fifth and sixth pieces of data. When the nodes in the indices vector in the CSR format of the outgoing edge out edge are sorted based on the edge type, it can be determined that the fifth location and the sixth location point to local identifiers of first-order neighbor nodes of the node 2 in the connection relationship in the edge type 3, for example, specifically the node identifiers 1 and 3.

Similarly, another node that points to the node 2 by using the edge type 3 can be determined by using the CSR formats of the incoming edge type in edge types and the incoming edge in edge. Therefore, a subgraph of the node 2 in the edge type 3 can be sampled.

Based on the above-mentioned principle, this specification provides a shard storage method for a graph and a subgraph sampling method for a graph. Both the methods can be performed by a single distributed device configured to store a single shard of a graph.

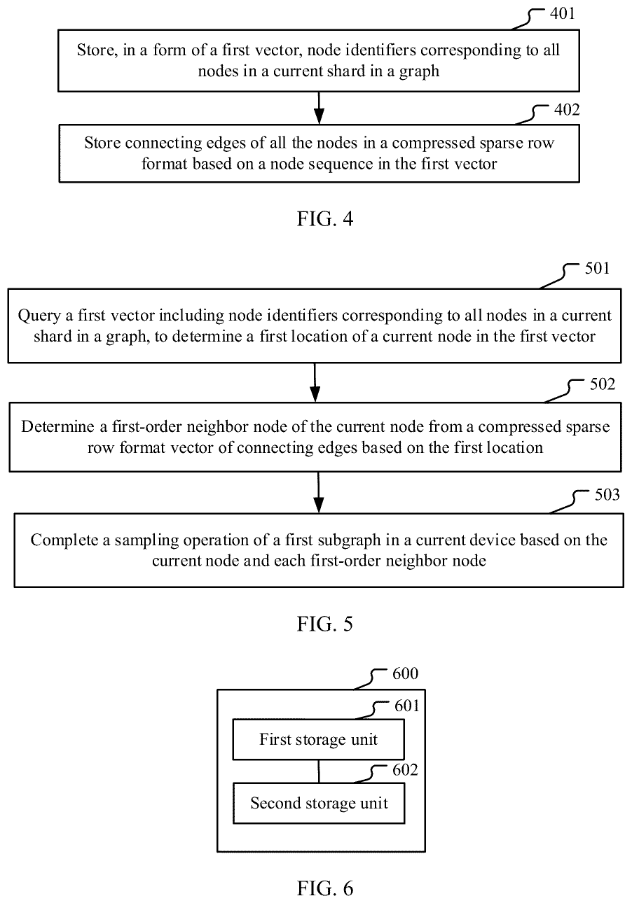

FIG. 4 shows a shard storage procedure for a graph according to an embodiment, used to store a current shard of the graph in a distributed system. The procedure can include the following steps.

Step 401: Store, in a form of a first vector, node identifiers corresponding to all nodes in the current shard in the graph.

The first vector is a global identifier vector (for example, global ids in FIG. 3), and records global node identifiers corresponding to all the nodes in the graph. A storage location (which can be denoted as a node location) of a node identifier of a single node in the first vector can be used as a local identifier (or denoted as a local ID) of the single node.

Step 402: Store connecting edges of all the nodes in a compressed sparse row format based on a node sequence in the first vector. The compressed sparse row format of the connecting edges can correspond to a first data vector, a first column index vector, and a first row statistics vector, the first data vector is used to record connecting edge identifiers, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes. For details, refer to the above-mentioned descriptions for FIG. 3. For example, in a compressed sparse row format of an outgoing edge (out edges), the first element 0 in a row statistics vector [0, 3, 3, 6, 9, 10, 11, 12] is an initial filler value, and a difference between each subsequent element and a previous element is a quantity of connecting edges of a node recorded at a corresponding location in the first vector (for example, global ids). Node locations of nodes connected to all the connecting edges are sequentially recorded in a column index vector [1, 2, 0, 1, 1, 3, 1, 4, 6, 2, 6, 1], and no space is retained for a location that has no connecting edge. When the connecting edge identifier is a predetermined value, the first data vector can be omitted from the compressed sparse row format of the connecting edges.

In a possible design, connecting edge types of all the nodes can be further stored in a compressed sparse row format based on the node sequence in the first vector. The compressed sparse row format of the connecting edge types can also correspond to a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes. For details, refer to the above-mentioned descriptions for FIG. 3. As described in a second row statistics vector [0, 3, 3, 5, 7, 8, 9, 10], a quantity of outgoing edge types of the first node 0 is a difference 3−0=3 between the second element and the first element, a quantity of outgoing edge types of the second node 1 is a difference 3−3=0 between the third element and the second element, and so on. A second column index vector [0, 2, 3, 2, 3, 0, 1, 3, 3, 1] describes an edge type identifier corresponding to the outgoing edge type of each node. For example, the three outgoing edge type identifiers of the first node 0 are 0, 2, and 3, two outgoing edge types of the third node 2 are 2 and 3, and so on. A second data vector [1, 2, 3, 4, 6, 8, 9, 10, 11, 12] sequentially records quantities of nodes corresponding to all the connecting edge types for all the nodes. For example, in the three outgoing edge types 0, 2, and 3 corresponding to the node 0, a quantity of nodes corresponding to the outgoing edge type 0 is 1, and so on.

It can be learned that when the graph is a directed graph, the connecting edges include an outgoing edge and an incoming edge, and storing the connecting edges of all the nodes in the compressed sparse row format based on the node sequence in the first vector includes: storing each of the outgoing edge and the incoming edge in a compressed sparse row format based on the node sequence in the first vector.

According to an optional implementation, for all the nodes, single nodes are sorted based on connecting edge types in the compressed sparse row format of the connecting edges. In this way, edge type-based retrieval can be conveniently performed.

FIG. 5 shows a subgraph sampling procedure for a graph according to an embodiment, used by a single distributed device in a distributed system that stores the graph to sample a first subgraph related to a current node in a locally stored graph shard. The procedure can include the following steps.

Step 501: Query a first vector including node identifiers corresponding to all nodes in a current shard in the graph, to determine a first location of the current node in the first vector.

A storage location of a node identifier of a single node in the first vector is used as a local identifier (or denoted as a local ID) of the single node. The first location can be determined by searching the first vector by using a dichotomy.

Step 502: Determine a first-order neighbor node of the current node from a compressed sparse row format vector of connecting edges based on the first location.

The compressed sparse row format of the connecting edges corresponds to at least a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes. A node identifier of each first-order neighbor node is determined in the following manner: determining, by using the first row statistics vector, a first quantity of connecting edges corresponding to the current node; and obtaining, based on a node location indicated by the first column index vector, an identifier of a node connected to the first quantity of connecting edges.

Step 503: Complete a sampling operation of the first subgraph in the current device based on the current node and each first-order neighbor node.

In an embodiment, the first quantity is a data difference between a first location and a previous location in the first row statistics vector.

According to an optional implementation, obtaining, based on the node location indicated by the first column index vector, the identifier of the node connected to the first quantity of connecting edges in step 502 includes:
determining the node location indicated by the first column index vector as a local identifier of a node connected to each connecting edge; and
querying a corresponding node identifier in the first vector based on the local identifier.

According to a possible design, single nodes are sorted based on connecting edge types in the compressed sparse row format of the connecting edges, the connecting edge types are stored in a compressed sparse row format of a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes; and determining the first-order neighbor node of the current node from the compressed sparse row format vector of connecting edges based on the first location in step 502 includes:
searching the second column index vector for quantities of connecting edges respectively corresponding to all edge types corresponding to the current node;
determining, based on the quantities of connecting edges and a storage location of the current node in the second data vector, a location range corresponding to an identifier of an edge type that needs to be sampled; and
obtaining, from the first vector based on the location range, a node identifier of each node connected to the edge type that needs to be sampled.

In an embodiment, the completing a sampling operation of the first subgraph in the current device based on the current node and each first-order neighbor node in step 503 can include:

performing neighbor node sampling on each first-order neighbor node based on a method of the current node until a predetermined condition is met to complete the sampling operation of the first subgraph in the current device.

The predetermined condition is, for example, that a neighbor node of a predetermined order of the current node is sampled, or a quantity of nodes sampled for the first subgraph reaches a predetermined quantity threshold.

In the above-mentioned process, according to the method provided in this embodiment of this specification, in a distributed storage process of a graph, local identifiers of a vertex and an edge are implicitly stored, data is stored in an ordered manner, and the local identifiers of the vertex and the edge are implicitly calculated, so that the local identifiers of the vertex and the edge can be implicitly calculated in a binary search manner, to save storage space of the local identifier and a mapping relationship between a local identifier and a global identifier. A connecting edge is stored in a CSR format, to ensure that a first-order neighbor of a node is contiguously stored in a memory. For a heterogeneous graph, a connecting edge type is also stored in a CSR format, there is no need to split all edges into a plurality of sparse matrices based on types, and query does not need to be performed across a plurality of sparse matrices in a sampling process. Therefore, better sampling performance can be achieved. In addition, because no complex container structure such as a map or a vector is introduced, there can be a higher data loading speed and lower memory occupation.

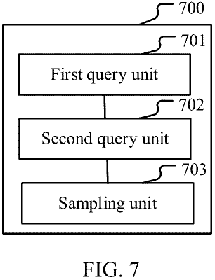

According to an embodiment in another aspect, a shard storage apparatus for a graph disposed in a single distributed device is further provided. As shown in FIG. 6, a shard storage apparatus 600 for a graph can be configured to store a current shard of the graph in a distributed system, and includes:
a first storage unit 601, configured to store, in a form of a first vector, node identifiers corresponding to all nodes in the current shard in the graph; and
a second storage unit 602, configured to store connecting edges of all the nodes in a compressed sparse row format based on a node sequence in the first vector, where the compressed sparse row format of the connecting edges corresponds to a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes.

According to an embodiment in still another aspect, a subgraph sampling apparatus for a graph disposed in a single distributed device in a distributed system that stores the graph is further provided, and can be configured to sample a first subgraph related to a current node in a locally stored graph shard. As shown in FIG. 7, a subgraph sampling apparatus 700 for a graph according to an embodiment can include:
a first query unit 701, configured to query a first vector including node identifiers corresponding to all nodes in a current shard in the graph, to determine a first location of the current node in the first vector;
a second query unit 702, configured to determine a first-order neighbor node of the current node from a compressed sparse row format vector of connecting edges based on the first location, where
the compressed sparse row format of the connecting edges corresponds to at least a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes; and a node identifier of each first-order neighbor node is determined in the following manner: determining, by using the first row statistics vector, a first quantity of connecting edges corresponding to the current node; and obtaining, based on a node location indicated by the first column index vector, an identifier of a node connected to the first quantity of connecting edges; and
a sampling unit 703, configured to complete a sampling operation of the first subgraph in the current device based on the current node and each first-order neighbor node.

It should be noted that the apparatuses 600 and 700 shown in FIG. 6 and FIG. 7 respectively correspond to the methods described in FIG. 4 and FIG. 5, and corresponding descriptions in the method embodiments shown in FIG. 4 and FIG. 5 are also applicable to the apparatuses 600 and 700. Details are not described herein.

According to an embodiment in another aspect, a computer-readable storage medium is further provided. The computer-readable storage medium stores a computer program, and when the computer program is executed in a computer, the computer is enabled to perform the method described with reference to FIG. 4, FIG. 5, etc.

According to an embodiment in still another aspect, a computing device is further provided, including a storage and a processor. The storage stores executable code, and when the processor executes the executable code, the method described with reference to FIG. 4, FIG. 5, etc. is implemented.

A person skilled in the art should be aware that in the above-mentioned one or more examples, the functions described in the embodiments of this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of the technical concepts of this specification are further described in detail in the above-mentioned specific implementations. It should be understood that the above-mentioned descriptions are merely specific implementations of the technical concepts of this specification, but are not intended to limit the protection scope of the technical concepts of this specification. Any modification, equivalent replacement, improvement, etc. made based on the technical solutions of the embodiments of this specification shall fall within the protection scope of the technical concepts of this specification.

1. A shard storage method for a graph, performed by a single distributed device, and used to store a current shard of the graph in a distributed system, wherein the method comprises:
storing, in a form of a first vector, node identifiers corresponding to all nodes in the current shard in the graph; and
storing connecting edges of all the nodes in a compressed sparse row format based on a node sequence in the first vector, wherein the compressed sparse row format of the connecting edges corresponds to a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes.

2. The method according to claim 1, wherein when the graph is a directed graph, the connecting edges comprise an outgoing edge and an incoming edge, and storing the connecting edges of all the nodes in the compressed sparse row format based on the node sequence in the first vector comprises:
storing each of the outgoing edge and the incoming edge in a compressed sparse row format based on the node sequence in the first vector.

3. The method according to claim 2, wherein for all the nodes, single nodes are sorted based on connecting edge types in the compressed sparse row format of the connecting edges.

4. The method according to claim 1, wherein the method further comprises:
storing connecting edge types of all the nodes in a compressed sparse row format based on the node sequence in the first vector, wherein the compressed sparse row format of the connecting edge types corresponds to a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes.

5. A subgraph sampling method for a graph, performed by a single distributed device in a distributed system that stores the graph, and used to sample a first subgraph related to a current node in a locally stored graph shard, wherein the method comprises:
querying a first vector comprising node identifiers corresponding to all nodes in a current shard in the graph, to determine a first location of the current node in the first vector;
determining a first-order neighbor node of the current node from a compressed sparse row format vector of connecting edges based on the first location, wherein the compressed sparse row format of the connecting edges corresponds to at least a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes; and a node identifier of each first-order neighbor node is determined in the following manner: determining, by using the first row statistics vector, a first quantity of connecting edges corresponding to the current node; and obtaining, based on a node location indicated by the first column index vector, an identifier of a node connected to the first quantity of connecting edges; and
completing a sampling operation of the first subgraph in the current device based on the current node and each first-order neighbor node.

6. The method according to claim 5, wherein the first quantity is a data difference between a first location and a previous location in the first row statistics vector.

7. The method according to claim 5, wherein the first location is determined by searching the first vector for a node identifier of the current node by using a dichotomy.

8. The method according to claim 5, wherein obtaining, based on the node location indicated by the first column index vector, the identifier of the node connected to the first quantity of connecting edges comprises:
determining the node location indicated by the first column index vector as a local identifier of a node connected to each connecting edge; and
querying a corresponding node identifier in the first vector based on the local identifier.

9. The method according to claim 5, wherein single nodes are sorted based on connecting edge types in the compressed sparse row format of the connecting edges, the connecting edge types are stored in a compressed sparse row format of a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes; and determining the first-order neighbor node of the current node from the compressed sparse row format vector of connecting edges based on the first location comprises:
searching the second column index vector for quantities of connecting edges respectively corresponding to all edge types corresponding to the current node;
determining, based on the quantities of connecting edges and a storage location of the current node in the second data vector, a location range corresponding to an identifier of an edge type that needs to be sampled; and
obtaining, from the first vector based on the location range, a node identifier of each node connected to the edge type that needs to be sampled.

10. The method according to claim 5, wherein completing the sampling operation of the first subgraph in the current device based on the current node and each first-order neighbor node comprises:
performing neighbor node sampling on each first-order neighbor node until a predetermined condition is met to complete the sampling operation of the first subgraph in the current device, wherein the predetermined condition is that a neighbor node of a predetermined order of the current node is sampled, or a quantity of nodes sampled for the first subgraph reaches a predetermined quantity threshold.

11. A computing device, comprising a storage and a processor, wherein the storage stores executable code, and when the processor executes the executable code, the computing device is caused to:
store, in a form of a first vector, node identifiers corresponding to all nodes in a current shard in a graph; and
store connecting edges of all the nodes in a compressed sparse row format based on a node sequence in the first vector, wherein the compressed sparse row format of the connecting edges corresponds to a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes.

12. The computing device according to claim 11, wherein when the graph is a directed graph, the connecting edges comprise an outgoing edge and an incoming edge, and the computing device being caused to store the connecting edges of all the nodes in the compressed sparse row format based on the node sequence in the first vector comprises being caused to:
store each of the outgoing edge and the incoming edge in a compressed sparse row format based on the node sequence in the first vector.

13. The computing device according to claim 12, wherein for all the nodes, single nodes are sorted based on connecting edge types in the compressed sparse row format of the connecting edges.

14. The computing device according to claim 11, wherein the computing device is further caused to:
store connecting edge types of all the nodes in a compressed sparse row format based on the node sequence in the first vector, wherein the compressed sparse row format of the connecting edge types corresponds to a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes.

15. The computing device according to claim 11, wherein the computing device is further caused to sample a first subgraph related to a current node in a locally stored graph shard by:
querying a first vector comprising node identifiers corresponding to all nodes in a current shard in the graph, to determine a first location of the current node in the first vector;
determining a first-order neighbor node of the current node from a compressed sparse row format vector of connecting edges based on the first location, wherein the compressed sparse row format of the connecting edges corresponds to at least a first column index vector and a first row statistics vector, the first row statistics vector is used to record, in a step-by-step cumulative manner, quantities of connecting edges corresponding to all the nodes, and the first column index vector is used to sequentially record node locations of other nodes connected to corresponding connecting edges in the first vector for all the nodes; and a node identifier of each first-order neighbor node is determined in the following manner: determining, by using the first row statistics vector, a first quantity of connecting edges corresponding to the current node; and obtaining, based on a node location indicated by the first column index vector, an identifier of a node connected to the first quantity of connecting edges; and
completing a sampling operation of the first subgraph in the current device based on the current node and each first-order neighbor node.

16. The computing device according to claim 15, wherein the first quantity is a data difference between a first location and a previous location in the first row statistics vector.

17. The computing device according to claim 15, wherein the first location is determined by searching the first vector for a node identifier of the current node by using a dichotomy.

18. The computing device according to claim 15, wherein obtaining, based on the node location indicated by the first column index vector, the identifier of the node connected to the first quantity of connecting edges comprises:
determining the node location indicated by the first column index vector as a local identifier of a node connected to each connecting edge; and
querying a corresponding node identifier in the first vector based on the local identifier.

19. The computing device according to claim 15, wherein single nodes are sorted based on connecting edge types in the compressed sparse row format of the connecting edges, the connecting edge types are stored in a compressed sparse row format of a second data vector, a second column index vector, and a second row statistics vector, the second row statistics vector is used to record, in a step-by-step cumulative manner, quantities of connecting edge types corresponding to all the nodes, the second column index vector is used to sequentially record edge type identifiers of the connecting edge types corresponding to all the nodes, and the second data vector is used to sequentially record quantities of nodes in all the connecting edge types for all the nodes; and determining the first-order neighbor node of the current node from the compressed sparse row format vector of connecting edges based on the first location comprises:
searching the second column index vector for quantities of connecting edges respectively corresponding to all edge types corresponding to the current node;
determining, based on the quantities of connecting edges and a storage location of the current node in the second data vector, a location range corresponding to an identifier of an edge type that needs to be sampled; and
obtaining, from the first vector based on the location range, a node identifier of each node connected to the edge type that needs to be sampled.

20. The computing device according to claim 15, wherein completing the sampling operation of the first subgraph in the current device based on the current node and each first-order neighbor node comprises:
performing neighbor node sampling on each first-order neighbor node until a predetermined condition is met to complete the sampling operation of the first subgraph in the current device, wherein the predetermined condition is that a neighbor node of a predetermined order of the current node is sampled, or a quantity of nodes sampled for the first subgraph reaches a predetermined quantity threshold.
